(19) United States
(12) Patent Application Publication
(10) Pub. No.: US 2023/0171855 A1
(43) Pub. Date: Jun. 1, 2023

(54) HEATER SHEET, AND VEHICLE-MOUNTED SENSOR COVER

(71) Applicant: NISSHA CO.,LTD., Kyoto (JP)

(72) Inventors: Kozo HIROTANI, Aichi (JP); Takahiro AOKI, Kyoto (JP)

(73) Assignee: NISSHA CO.,LTD., Kyoto (JP)

(21) Appl. No.: 17/919,283

(22) PCT Filed: Apr. 19, 2021
(86) PCT No.: PCT/JP2021/015816

§ 371 Date: Oct. 17, 2022

(30) Foreign Application Priority Data
Apr. 27, 2020 (JP) 2020-078136

(51) Int. Cl. H05B 3/16

(52) U.S. Cl. CPC H05B 3/16; H05B 2203/016; G01S 7/4047

(57) ABSTRACT

A heater sheet is configured to be applied to a cover of a vehicle-mounted sensor. The heater sheet is provided with a sheet substrate which is attached to the cover, and at least one heat generating strip which is provided along the sheet substrate. The heat generating strip is formed in a mesh shape in which a large number of filamentous first electrical conductors and a large number of filamentous second electrical conductors intersect one another. The first electrical conductors and the second electrical conductors are arranged in such a way as to be inclined relative to a horizontal direction.

### TECHNICAL FIELD

The disclosure relates to a heater sheet and a vehicle-mounted sensor cover.

### RELATED ART

A vehicle such as an automobile may be provided with a vehicle-mounted sensor. The vehicle-mounted sensor is configured to transmit and receive an electromagnetic wave for detecting an object outside the vehicle. On such a vehicle, in order to render the vehicle-mounted sensor less visible from outside of the vehicle, a vehicle-mounted sensor cover through which the electromagnetic wave can be transmitted is provided. The vehicle-mounted sensor cover is arranged in front of the vehicle-mounted sensor in an electromagnetic wave transmission direction. In the vehicle-mounted sensor cover, transmittance with respect to the electromagnetic wave is reduced by adhered ice and snow. Hence, a heater sheet for melting the adhered ice and snow is attached to the vehicle-mounted sensor cover.

The heater sheet includes a sheet substrate attached to the vehicle-mounted sensor cover, and a heat generating strip provided along the sheet substrate and generating heat by being energized. As the heat generating strip, it is conceivable that the one disclosed in, for example, Patent Document 1, is adopted. This heat generating strip is formed in a grid pattern in which filamentous electrical conductors are extended in a horizontal direction and a vertical direction and intersect each other. Ice and snow adhering to the vehicle-mounted sensor cover are melted through heat generation of the heat generating strip in the heater sheet.

### PRIOR-ART DOCUMENTS

### Patent Documents

Patent Document 1: Japanese Patent Laid-open No. 2019-160800

### SUMMARY OF THE INVENTION

### Problems to Be Solved by the Invention

The vehicle-mounted sensor transmits the electromagnetic wave so as to spread it horizontally. Hence, the electrical conductor extending in the horizontal direction in the heat generating strip may obstruct the transmission of the electromagnetic wave through the heat generating strip. In detail, the electromagnetic wave transmitted from the vehicle-mounted sensor so as to spread in the horizontal direction is interfered with by the electrical conductor extending in the horizontal direction in the heat generating strip, and therefore becomes less likely to be transmitted through the heat generating strip.

An object of the disclosure is to provide a heater sheet and a vehicle-mounted sensor cover in which an electromagnetic wave can be transmitted through a heat generating strip with reduced difficulty.

### Means for Solving the Problems

A heater sheet that solves the above-mentioned problem is a heater sheet configured to be applied to a cover of a vehicle-mounted sensor transmitting and receiving an electromagnetic wave for detecting an object outside a vehicle. The cover is configured to be located in front of the vehicle-mounted sensor in an electromagnetic wave transmission direction. The heater sheet includes a sheet substrate attached to the cover, and at least one heat generating strip provided along the sheet substrate. The heat generating strip is formed in a mesh shape in which a large number of filamentous first electrical conductors and a large number of filamentous second electrical conductors intersect each other. The first electrical conductor and the second electrical conductor are arranged so as to be inclined relative to a horizontal direction.

A vehicle-mounted sensor cover that solves the above-mentioned problem is configured to be located in front of a vehicle-mounted sensor that transmits and receives an electromagnetic wave for detecting an object outside a vehicle in an electromagnetic wave transmission direction, and has the above-mentioned heater sheet attached thereto.

### BRIEF DESCRIPTION OF THE DRAWINGS

FIG. 1 is a plan sectional view showing the vicinity of a vehicle-mounted sensor in a front part of a vehicle.

FIG. 2 is a rear view showing a sheet substrate, a heat generating strip and the like of a heater sheet as viewed from a rear side of the vehicle.

FIG. 3 is an enlarged view showing the heat generating strip of the heater sheet and its vicinity.

FIG. 4 is a schematic view showing inclination of a first electrical conductor and a second electrical conductor of the heat generating strip relative to a vertical direction.

### DESCRIPTION OF THE EMBODIMENTS

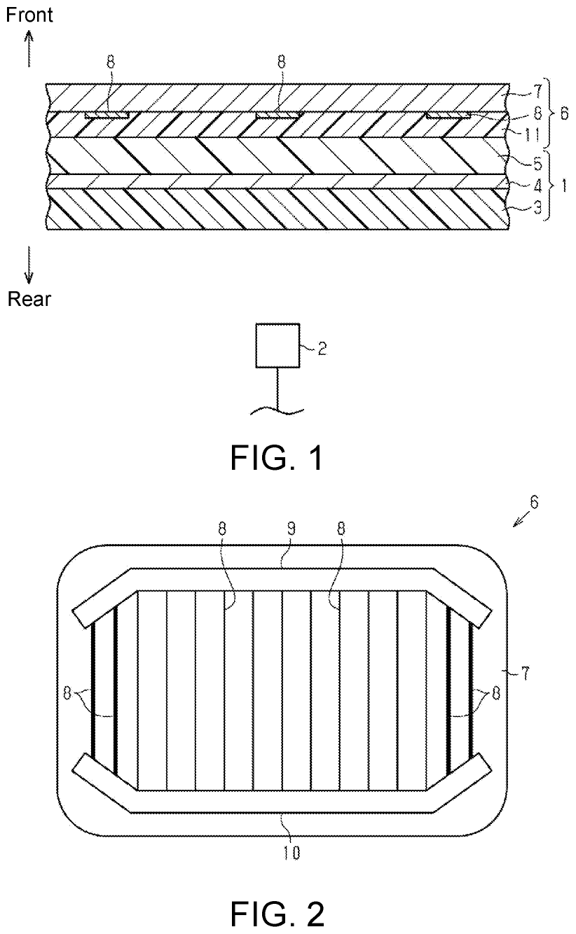

An embodiment of a heater sheet and a vehicle-mounted sensor cover will be described below with reference to FIG. 1 to FIG. 4.

As shown in FIG. 1, a front part of a vehicle such as an automobile is equipped with a millimeter wave radar 2 as a vehicle-mounted sensor that transmits and receives an electromagnetic wave for detecting an object outside the vehicle. The millimeter wave radar 2 is configured to, while transmitting a radio wave (millimeter wave) toward the outside of the vehicle (upper side in FIG. 1), receive the millimeter wave reflected by the object outside the vehicle, so as to detect the object outside the vehicle through such millimeter wave transmission and reception.

In the front part of the vehicle, on a front side (upper side in FIG. 1) of the millimeter wave radar 2 in a millimeter wave transmission direction, a vehicle-mounted sensor cover 1 is provided for rendering the millimeter wave radar 2 less visible from outside of the vehicle. The vehicle-mounted sensor cover 1 is able to transmit the above millimeter wave. As the vehicle-mounted sensor cover 1, it is conceivable to adopt one having a design such as a vehicle emblem.

The vehicle-mounted sensor cover 1 includes a substrate 3 attached to the vehicle, a decorating layer 4 having a design, and a transparent layer 5 rendering the decorating layer 4 visible from outside of the vehicle while covering the decorating layer 4. The substrate 3, the decorating layer 4, and the transparent layer 5 are provided in order from a rear side (lower side in FIG. 1) to the front side (upper side in FIG. 1) in the millimeter wave transmission direction from the millimeter wave radar 2.

The substrate 3 includes an attachment part such as a claw for attaching the vehicle-mounted sensor cover 1 to the vehicle. The substrate 3 is made of a material that is able to ensure rigidity capable of realizing the attachment of the vehicle-mounted sensor cover 1 to the vehicle via the attachment part and allows the millimeter wave to be transmitted therethrough. Examples of such a material include acrylonitrile-ethylene-propylene-diene-styrene (AES) and acrylonitrile-styrene-acrylic rubber (ASA).

The decorating layer 4 is formed using a method such as painting, film insert molding, and sputtering, so as to have an arbitrary design. The decorating layer 4 also allows the millimeter wave to be transmitted therethrough. The transparent layer 5 is made of a resin that is colorless and transparent or colored and transparent and allows the millimeter wave to be transmitted therethrough. Examples of such a resin include polycarbonate.

A heater sheet 6 for melting ice and snow adhering to the vehicle-mounted sensor cover 1 so as to prevent the ice and snow from reducing transmittance with respect to the millimeter wave is attached to a surface of the vehicle-mounted sensor cover 1 on the front side of the vehicle. The heater sheet 6 includes a sheet substrate 7 attached to the vehicle-mounted sensor cover 1 (transparent layer 5), and a plurality of heat generating strips 8 provided along the sheet substrate 7 and generating heat by being energized.

Next, the heater sheet 6 will be described in detail.

FIG. 2 shows the sheet substrate 7, the heat generating strip 8 and the like in the heater sheet 6 of FIG. 1 as viewed from the rear side (lower side in FIG. 1) of the vehicle. As is clear from FIG. 2, a pair of horizontally extending upper and lower bus bars 9 and 10 are attached to a surface of the sheet substrate 7 on the rear side of the vehicle. That is, the heater sheet 6 includes the bus bars 9 and 10 in addition to the sheet substrate 7 and the heat generating strip 8. In the pair of upper and lower bus bars 9 and 10, a vertical interval between both ends of the bus bar 9 in the horizontal direction and both ends of the bus bar 10 in the horizontal direction has a different value from that of a vertical interval between central parts of the bus bars 9 and 10 in the horizontal direction. In detail, the vertical interval between both ends of the bus bar 9 in the horizontal direction and both ends of the bus bar 10 in the horizontal direction is shorter than the vertical interval between the central parts of the bus bars 9 and 10 in the horizontal direction. This is because the bus bars 9 and 10 are bent in a longitudinal direction in accordance with an outer edge shape of the vehicle-mounted sensor cover 1 (emblem).

The plurality of heat generating strips 8 extend in a vertical direction so as to connect the pair of upper and lower bus bars 9 and 10 and are arranged at intervals in the horizontal direction. Each heat generating strip 8 is energized through the pair of upper and lower bus bars 9 and 10, so that each heat generating strip 8 generates heat through such energization. As shown in FIG. 1, an adhesive layer 11 for attaching the bus bars 9 and 10 and the heat generating strip 8 to the sheet substrate 7 is formed on the surface of the sheet substrate 7 on the rear side of the vehicle.

The sheet substrate 7 and the adhesive layer 11 of the heater sheet 6 are made of a resin (for example, polycarbonate) that is colorless and transparent or colored and transparent and allows the millimeter wave to be transmitted therethrough. The heater sheet 6 formed in this way is attached to the surface of the vehicle-mounted sensor cover 1 on the front side of the vehicle. Thus, due to the fact that the heat generating strip 8 of the heater sheet 6 generates heat by being energized, the ice and snow adhering to the vehicle-mounted sensor cover 1 may be melted.

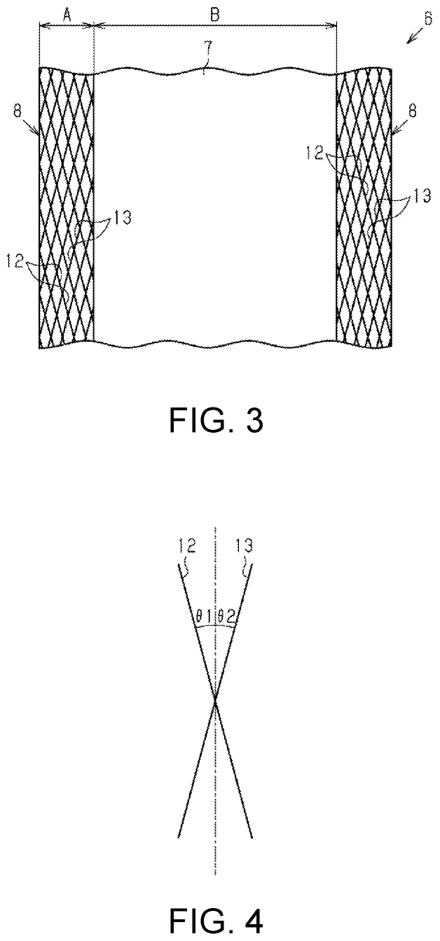

As shown in FIG. 3, a width A of the heat generating strip 8 in the horizontal direction may be, for example, 50 to 300 μm. An interval B between the plurality of heat generating strips 8 in the horizontal direction may be, for example, 1 to 6 mm Each heat generating strip 8 is formed in a mesh shape in which a large number of filamentous first electrical conductors 12 and a large number of filamentous second electrical conductors 13 intersect each other. As shown in FIG. 4, the first electrical conductor 12 and the second electrical conductor 13 are arranged so as to be inclined relative to the horizontal direction. At least one of the first electrical conductor 12 and the second electrical conductor 13 is arranged so as to have an inclination angle of greater than 0° and within 15° relative to the vertical direction. In this example, an inclination angle θ1 of the first electrical conductor 12 relative to the vertical direction is set to 15°. An inclination angle θ2 of the second electrical conductor 13 relative to the vertical direction is also set to 15°.

As shown in FIG. 2, in the pair of upper and lower bus bars 9 and 10, the vertical interval between both ends of the bus bar 9 in the horizontal direction and both ends of the bus bar 10 in the horizontal direction is shorter than the vertical interval between the central parts of the bus bars 9 and 10 in the horizontal direction. Considering this, the heat generating strip 8 that connects both ends of the bus bar 9 in the horizontal direction and both ends of the bus bar 10 in the horizontal direction and the heat generating strip 8 that connects the central parts of the bus bars 9 and 10 in the horizontal direction are formed so that electrical resistance values of both heat generating strips are close to each other. In detail, to bring the electrical resistance value of the heat generating strip 8 that connects both ends of the bus bar 9 and both ends of the bus bar 10 and the electrical resistance value of the heat generating strip 8 that connects the central parts of the bus bars 9 and 10 close to each other, at least one of a thickness of the heat generating strips 8 in a direction orthogonal to the paper surface of FIG. 3, the width A of the heat generating strips 8 in a left-right direction (horizontal direction) in FIG. 3, and a length of the heat generating strips 8 in the vertical direction is adjusted.

In this example, through the adjustment of the thickness and the width A of the heat generating strip 8, the electrical resistance values of the above two heat generating strips 8 are brought close to each other. Since the thickness of the heat generating strip 8 in the direction orthogonal to the paper surface of FIG. 2 and FIG. 3 varies depending on a diameter of the first electrical conductor 12 and the second electrical conductor 13, the thickness can be adjusted through a change in the diameter of the first electrical conductor 12 and the second electrical conductor 13.

Next, effects of the heater sheet 6 and the vehicle-mounted sensor cover 1 in the present embodiment will be described.

(1) The heater sheet 6 includes the sheet substrate 7 attached to the vehicle-mounted sensor cover 1, and the heat generating strip 8 provided along the sheet substrate 7 and having conductivity. The heat generating strip 8 is formed in a mesh shape in which a large number of filamentous first electrical conductors 12 and a large number of filamentous second electrical conductors 13 intersect each other. The first electrical conductor 12 and the second electrical conductor 13 are arranged so as to be inclined relative to the horizontal direction. Hence, the following situation is prevented from occurring. That is, a millimeter wave transmitted from the millimeter wave radar 2 so as to spread in the horizontal direction is interfered with by an electrical conductor extending in the horizontal direction in the heat generating strip 8, and therefore becomes less likely to be transmitted through the heat generating strip 8. Thus, the above millimeter wave can be transmitted through the heat generating strip 8 with reduced difficulty.

(2) At least one (both in this example) of the first electrical conductor 12 and the second electrical conductor 13 is arranged so as to have an inclination angle of greater than 0° and within 15° relative to the vertical direction. In detail, while the inclination angle θ1 of the first electrical conductor 12 relative to the vertical direction is set to 15 °, the inclination angle θ2 of the second electrical conductor 13 relative to the vertical direction is set to 15 °. Accordingly, the millimeter wave transmitted from the millimeter wave radar 2 so as to spread in the horizontal direction is relatively less likely to be interfered with by the first electrical conductor 12 and the second electrical conductor 13. Thus, the above millimeter wave can be transmitted through the heat generating strip 8 with relatively effectively reduced difficulty.

(3) In contrast with the millimeter wave transmitted from the millimeter wave radar 2 so as to spread in the horizontal direction, each heat generating strip 8 extends in the vertical direction. Furthermore, the interval between the heat generating strips 8 in the horizontal direction is set to 1 to 6 mm Accordingly, while the required heat generation performance of the heater sheet 6 is secured, the transmittance with respect to the above millimeter wave can be improved.

(4) The heater sheet 6 includes a pair of upper and lower bus bars 9 and 10. In accordance with the outer edge shape of the vehicle-mounted sensor cover 1, the vertical interval between both ends of the bus bar 9 in the horizontal direction and both ends of the bus bar 10 in the horizontal direction has a different value from that of the vertical interval between the central parts of the bus bars 9 and 10 in the horizontal direction. In the heat generating strip 8 that connects both ends of the bus bar 9 in the horizontal direction and both ends of the bus bar 10 in the horizontal direction and the heat generating strip 8 that connects the central parts of the bus bars 9 and 10 in the horizontal direction, at least one of the thickness, the width A and the length of the heat generating strips 8 is adjusted so that the electrical resistance values of both heat generating strips 8 are close to each other. Accordingly, it can be prevented that the electrical resistance value of the heat generating strip 8 that connects both ends of the bus bar 9 and both ends of the bus bar 10 and the electrical resistance value of the heat generating strip 8 that connects the central parts of the bus bars 9 and 10 are excessively different from each other so that unbalance occurs between both heat generating strips 8 in heat generation performance.

The above embodiment can be modified, for example, as follows. The above embodiment and the following modification can be implemented in combination with each other without any technical conflict.

The inclination angles θ1 and θ2 of the first electrical conductor 12 and the second electrical conductor 13 relative to the vertical direction can be changed as appropriate. It is fine that only one of the inclination angle θ1 and the inclination angle θ2 is greater than 0° and within 15° by such a change. One of the inclination angle θ1 and the inclination angle θ2 may be set to 0°.

In the heat generating strip 8 that connects both ends of the bus bar 9 in the horizontal direction and both ends of the bus bar 10 in the horizontal direction and the heat generating strip 8 that connects the central parts of the bus bars 9 and 10 in the horizontal direction, the length of the heat generating strips 8 may be adjusted so that the electrical resistance values of both heat generating strips 8 are close to each other. Such a length adjustment may be performed by, for example, causing the heat generating strip 8 extending in the vertical direction to meander in a front-rear direction of the vehicle, that is, a millimeter wave transmission and reception direction in the millimeter wave radar 2.

A distance between the pair of upper and lower bus bars 9 and 10 in the vertical direction does not necessarily have to be different between both ends and central parts of the bus bars 9 and 10 in the longitudinal direction.

The interval B between the heat generating strips 8 in the horizontal direction may be changed as appropriate.

The width A of the heat generating strip 8 in the horizontal direction may be changed as appropriate.

The heat generating strip 8 may extend in a slightly inclined state relative to the vertical direction.

An infrared sensor that transmits and receives an infrared ray as the electromagnetic wave may be used in place of the millimeter wave radar 2 as the vehicle-mounted sensor that transmits and receives the electromagnetic wave.

### DESCRIPTION OF REFERENCE NUMERALS

1: vehicle-mounted sensor cover
2: millimeter wave radar
3: substrate
4: decorating layer
5: transparent layer
6: heater sheet
7: sheet substrate
8: heat generating strip
9: bus bar
10: bus bar
11: adhesive layer
12: first electrical conductor
13: second electrical conductor

1. A heater sheet, configured to be applied to a cover of a vehicle-mounted sensor, the vehicle-mounted sensor transmitting and receiving an electromagnetic wave for detecting an object outside a vehicle, the cover being configured to be located in front of the vehicle-mounted sensor in an electromagnetic wave transmission direction, wherein the heater sheet comprises:
a sheet substrate, attached to the cover; and
at least one heat generating strip, provided along the sheet substrate, wherein
the at least one heat generating strip is formed in a mesh shape in which a large number of first electrical conductors in a filamentous shape and a large number of second electrical conductors in a filamentous shape intersect each other, and
the large number of first electrical conductors and the large number of second electrical conductors are arranged so as to be inclined relative to a horizontal direction.

2. The heater sheet according to claim 1, wherein
at least one of each of the large number of first electrical conductors and each of the large number of second electrical conductors is arranged so as to have an inclination angle of greater than 0° and within 15° relative to a vertical direction.

3. The heater sheet according to claim 1, wherein
the at least one heat generating strip comprises a plurality of heat generating strips extending in a vertical direction and arranged at intervals of 1 to 6 mm in the horizontal direction.

4. The heater sheet according to claim 1, comprising:
a pair of upper and lower bus bars extending in the horizontal direction, wherein
the at least one heat generating strip comprises a plurality of heat generating strips extending in a vertical direction so as to connect the pair of upper and lower bus bars and arranged at intervals in the horizontal direction;
a vertical interval between both ends of one of the pair of upper and lower bus bars in the horizontal direction and both ends of the other bus bar in the horizontal direction has a different value from that of a vertical interval between central parts of two bus bars in the horizontal direction;
among the plurality of heat generating strips, at least one of a thickness, a width and a length of the heat generating strip that connects the both ends of the one of the bus bars and the both ends of the other bus bar and the heat generating strip that connects the central parts of the two bus bars is adjusted so that electrical resistance values of both heat generating strips are close to each other.

5. A vehicle-mounted sensor cover, configured to be located in front of a vehicle-mounted sensor that transmits and receives an electromagnetic wave for detecting an object outside a vehicle in an electromagnetic wave transmission direction, having the heater sheet according to claim 1, attached thereto.

6. The heater sheet according to claim 2, wherein
the at least one heat generating strip comprises a plurality of heat generating strips extending in the vertical direction and arranged at intervals of 1 to 6 mm in the horizontal direction.

7. The heater sheet according to claim 2, comprising:
a pair of upper and lower bus bars extending in the horizontal direction, wherein
the at least one heat generating strip comprises a plurality of heat generating strips extending in the vertical direction so as to connect the pair of upper and lower bus bars and arranged at intervals in the horizontal direction;
a vertical interval between both ends of one of the pair of upper and lower bus bars in the horizontal direction and both ends of the other bus bar in the horizontal direction has a different value from that of a vertical interval between central parts of two bus bars in the horizontal direction;
among the plurality of heat generating strips, at least one of a thickness, a width and a length of the heat generating strip that connects the both ends of the one of the bus bars and the both ends of the other bus bar and the heat generating strip that connects the central parts of the two bus bars is adjusted so that electrical resistance values of both heat generating strips are close to each other.

8. The heater sheet according to claim 3, comprising:
a pair of upper and lower bus bars extending in the horizontal direction, wherein
the at least one heat generating strip comprises a plurality of heat generating strips extending in the vertical direction so as to connect the pair of upper and lower bus bars and arranged at intervals in the horizontal direction;
a vertical interval between both ends of one of the pair of upper and lower bus bars in the horizontal direction and both ends of the other bus bar in the horizontal direction has a different value from that of a vertical interval between central parts of two bus bars in the horizontal direction;
among the plurality of heat generating strips, at least one of a thickness, a width and a length of the heat generating strip that connects the both ends of the one of the bus bars and the both ends of the other bus bar and the heat generating strip that connects the central parts of the two bus bars is adjusted so that electrical resistance values of both heat generating strips are close to each other.

9. The heater sheet according to claim 6, comprising:
a pair of upper and lower bus bars extending in the horizontal direction, wherein
the at least one heat generating strip comprises a plurality of heat generating strips extending in the vertical direction so as to connect the pair of upper and lower bus bars and arranged at intervals in the horizontal direction;
a vertical interval between both ends of one of the pair of upper and lower bus bars in the horizontal direction and both ends of the other bus bar in the horizontal direction has a different value from that of a vertical interval between central parts of two bus bars in the horizontal direction;
among the plurality of heat generating strips, at least one of a thickness, a width and a length of the heat generating strip that connects the both ends of the one of the bus bars and the both ends of the other bus bar and the heat generating strip that connects the central parts of the two bus bars is adjusted so that electrical resistance values of both heat generating strips are close to each other.

10. A vehicle-mounted sensor cover, configured to be located in front of a vehicle-mounted sensor that transmits and receives an electromagnetic wave for detecting an object outside a vehicle in an electromagnetic wave transmission direction, having the heater sheet according to claim 2 attached thereto.

11. A vehicle-mounted sensor cover, configured to be located in front of a vehicle-mounted sensor that transmits and receives an electromagnetic wave for detecting an object outside a vehicle in an electromagnetic wave transmission direction, having the heater sheet according to claim 3 attached thereto.

12. A vehicle-mounted sensor cover, configured to be located in front of a vehicle-mounted sensor that transmits and receives an electromagnetic wave for detecting an object outside a vehicle in an electromagnetic wave transmission direction, having the heater sheet according to claim 4 attached thereto.
